(19) United States
(12) Patent Application Publication
(10) Pub. No.: US 2003/0220936 A1
(43) Pub. Date: Nov. 27, 2003

(54) Software architecture for managing binary objects

(76) Inventor: John H. Gifford, San Francisco, CA (US)

Correspondence Address: Andrew V. Smith, Sierra Patent Group, Ltd., P.O. Box 6149, Stateline, NV, 89449, US

(21) Appl. No.: 10/154,440

(22) Filed: May 22, 2002

(51) Int. Cl. G06F 7/00

(52) U.S. Cl. 707/103 Y

(57) ABSTRACT

A software architecture for managing binary objects includes a binary object manager program module for calling stored database procedures, a data delivery module for receiving a data array including sufficient data to instantiate a specific binary object, and a database module. The database module includes stored data relating to the binary objects and one or more stored procedures for managing and delivering binary object-related data through the binary object manager program module. The software architecture manages interface-based binary objects and can simultaneously manage the life and manipulate capabilities of the binary objects of arbitrary type. Objects may be chosen and then managed to accomplish computer-based, systematic activities. The user-developer's construction performs similarly to computer programs.

### BACKGROUND OF THE INVENTION

1. Field of the Invention

The invention relates to binary object management software, and particularly including a database module including one or more stored procedures for managing and delivering binary object-related data.

2. Description of the Related Art

Creating and using interface-based binary objects as building blocks is a standard software construction activity. One implementation of an interface-based binary object model and system that follows characteristics of binary objects management is the Component Object Model or COM as provided by Microsoft® Corporation as part of their Object Linking and Embedding (OLE) and ActiveX™ software technology. Virtually all of Microsoft® software releases include a COM access approach. Third-party software companies often find this approach appropriate. Existing software that is not COM accessible often can be easily upgraded by ‘wrapping’ a small amount of new code around the unchanged existing code modules.

However, conventional practice by software engineers continues to treat binary objects as specific solutions to specific problems. One of the original promises of those generally espousing universally available objects was that there was to be a combinatorial synergy. While this synergy appears when specific objects are laboriously combined, the development/maintenance overhead has largely negated the utility gained. This is especially true with interface-based binary objects because both the creation of the binary object and effective interfacing with others is not simple and has only achieved much significant use among Visual Basic developers.

Another high-potential developer tool is the SQL Database. While there is almost universal inclusion of database access in software developed, it remains relatively low level and unexploited because of the cost of efficient, low-maintenance interface code. A notable deficiency in conventional practice is a very low regard for data sets. The SQL relational database has always been able to add, modify and delete its data table and field records with little or no variability in performance time regardless of the data involved. Yet, it is common for conventional software to process one or only a few data tables and fields at a time.

In U.S. Pat. No. 6,230,318 to Halstead et al. and Microsoft Corp., which is hereby incorporated by reference, a single application program constructed entirely from a tree structure is described. In U.S. Pat. No. 6,169,993 to Shutt et al., which is also hereby incorporated by reference, a repository of stored object states is formed that can be accessed by later created objects of the same class or of a new extended class. These programs do not provide a desired degree of functionality, versatility or flexibility. It is therefore desired to have a software architecture capable of integrating an SQL database with interface-based binary objects, a browser and/or other application-based databases. Such combination of disparate and/or pre-existing binary sources may advantageously perform as a computer application program. In addition, fixed format SQL databases data may be advantageously varied to adapt to the desired results of a target program.

### SUMMARY OF THE INVENTION

In view of the above, a software architecture is provided, as well as methods and computer systems using one or more processors and data storage hardware, for managing binary objects including a binary object manager program module for calling stored database procedures, a data delivery module for receiving a data array including sufficient data to instantiate a specific binary object, and a database module. The database module includes stored data relating to the binary objects and one or more stored procedures for managing and delivering binary object-related data through the binary object manager program module.

In a preferred embodiment, the data delivery module sets a current array value to zero and makes a next array the current array. The current array is then upacked and a target destination for the current array is identified. Then, an iteration of the current array is delivered to the target destination, after which the iteration for the current array is completed and the data delivery module gets a further input data array. This further input array is made the current array and a current array value is incremented by one. Otherwise, the data delivery iteration is stopped.

The identified target destination may be the binary object manager program module. In this case, the data array may be received with an existing volatile object pointer index of null or a value other than null. When the existing volatile object pointer index is null, a binary object may be created by the binary object manager program module using an object name. Then, output data is prepared for delivery including setting up the data array and identifying a next target destination for the data array. The output data is sent to the next target destination for a new data delivery iteration. The binary object data may also be released and a no-data return sent to the binary object manager program module to perform a new data delivery iteration.

When the existing volatile object pointer index is a value other than null, the binary object index value may be used to select a binary object to reference. A binary object may then be created using a parent binary object. In this case, output data is again then prepared for delivery including setting up the data array and identifying a next target destination for the data array, the output data is sent to the next target destination for a new data delivery iteration. And again, the binary object data may also be released and a no-data return sent to the binary object manager program module to perform a new data delivery iteration.

The volatile object pointer index value may also be used to select a binary object volatile pointer. This binary object volatile pointer may be used to prepare a managed object target function, which may be executed by invoking a binary object runtime interface function. The binary object volatile pointer may also be used to prepare a property access call, which may be executed by invoking a binary object runtime interface function. In either case, as before, the binary object data may also be released and a no-data return sent to the binary object manager program module to perform a new data delivery iteration.

The data delivery module may also identify the database module as the target destination for the data array. The database module receives the data array with an existing volatile object pointer index value of null or a value other than null. When the index is null, the binary object may be created and manipulated. An “event has fired” call is received by the database module, and in response, an “event has fired” database procedure call is prepared, and preferably a next data array is delivered to a database. Then, output data is prepared for delivery including setting up the next data array, and identifying a next target destination for the next data array. The output data is then sent to the next target destination for a new data delivery iteration.

When the existing volatile pointer index value received is has value other than null, then preferably the database module uses the volatile object pointer index value to select a binary object to reference. A binary object is then created using a parent binary object. The database module receives an “event has fired” call, and in response, prepares an “event has fired” database procedure call. Then, again, output data is prepared for delivery including setting up the next data array, and identifying a next target destination for the next data array, and the output data is then sent to the next target destination for a new data delivery iteration.

The data delivery module may deliver an iteration of the current data array to a target destination. This data delivery iteration may then preferably include setting the current array value to zero, receiving a next data array, unpacking the next data array, identifying the target destination for the data array, and sending the array to the target destination. The target destination may include the binary object manager program module or the database module.

The preferred architecture may further include a module for ending the life of managed binary objects. The module may receive an “event has fired” call, and in response, may prepare an “event has fired” database procedure call. A data array may be received having sufficient data to instantiate a specific binary object, and then output data may be prepared for delivery including setting up the data array and identifying a next target destination for the data array. The module may then send the output data to the next target destination for a new data delivery iteration. A data array received from the data delivery module by the module for ending the life of managed binary objects may either include or not an object Id. When the object Id is not included, all binary objects referencing all binary object pointer indexes at root pointer may be released. When the object Id is included, a single volatile object pointer may be referenced corresponding to the object Id provided, and a designated object is released.

Data is preferably delivered as one or more data arrays each paired with a data header. The data delivery package preferably also includes a data transaction header.

A runtime interface preferably executes and accesses object functions and properties, which may include an event establishing function. A firing of the event may result in a database procedure call. The runtime interface may include an invoking function for executing a function and/or accessing a property of the object.

A root pointer preferably manages a life of a binary object. The root pointer may further end a life of a binary object. An object may be created using a parent object from the root pointer, or using an object name.

A volatile object pointer index preferably selects binary objects to reference. An object may be created using a parent object from the root pointer or using an object name, and then the output may be prepared for data delivery.

### BRIEF DESCRIPTION OF THE DRAWINGS

FIG. 1 is an architectural diagram in accordance with a preferred embodiment.

FIG. 2 is a logical diagram illustrating the management of interface-based binary objects in accordance with a preferred embodiment.

FIG. 3 is a detailed diagram illustrating data delivery among architectural elements and their functional areas in accordance with a preferred embodiment.

FIG. 4 is a data flow diagram illustrating a closed operational environment for a software architecture in accordance with a preferred embodiment.

FIG. 5 is a detailed diagram delineating creation of active binary objects in accordance with a preferred embodiment.

FIG. 6 is a detailed diagram illustrating the closing of open binary objects in accordance with a preferred embodiment.

FIG. 7 is a diagram that illustrates the execution of binary object functions and reading or modifying properties in accordance with a preferred embodiment.

### INCORPORATION BY REFERENCE

U.S. Pat. Nos. 6,169,993 and 6,230,318 are, in addition to the background, invention summary and brief description of the drawings above, and the abstract of the disclosure, hereby incorporated by reference into the detailed description of the preferred embodiments below, as disclosing alternative embodiments of elements or features of the preferred embodiments not otherwise set forth in detail below. A single one or a combination of two or more of these references may be consulted to obtain a variation of the preferred embodiments described in the detailed description below.

### DETAILED DESCRIPTION OF THE PREFERRED EMBODIMENTS

In general with respect to the preferred embodiments, there is a binary object manager computer program and a database that communicate with themselves and each other. Communication may involve developer-prepared chunks of data delivered to control the life of binary objects and dynamically manipulate their activities. The life and activities of a binary object may be managed at the time and in the sequence of delivered data. The data delivery format may be a series of simple two-dimensional arrays. Arrays may be introduced by a header that tells the architectural element how to use the data array.

A user-developer and software architecture in accordance with a preferred embodiment may artfully arrange data in the database, prepare data delivery contents, and manage delivery timing and sequence. When the architectural elements communicate with themselves and each other in accord with a preferred embodiment, the user-developer may arrange for an initial, bootstrap data delivery. This initial action may follow the startup of the preferred manager program or database. The developer may use object functions and database procedures to realize desired activities. Execution of functions and procedures may result from initialization and/or other triggering mechanisms such as object events. For objects that have them, the developer may ‘wire up’ events on managed binary objects. The end-user of a developer's desired activities is often empowered to cause events. An event firing may cause execution of a developer-prepared database procedure.

Caller information regarding preferred interface-based binary objects may be advantageously conducive to low-effort database data preparation. Opening an object may involve utilizing the name of the object or a pointer to another existing object that is capable of instantiating a new object. Once active, an object can be managed by its runtime interface having an ‘invoking’ function, such as may be understood by those skilled in the art. The invoking function may use an identifier that uniquely selects the desired object function or property involved and parameters that match the selected function or property. The invoking function may execute the selected function and return results.

A developer may open a binary object by calling a database stored procedure that delivers the object name or an existing object that can be its parent. Further use of the new object may then be possible by other stored procedure output that includes the function or property and its parameters.

A preferred computer program product has specific data delivery formats to achieve its purpose. This preferably includes a few mandatory database stored procedures with fixed parameters. An example may be handling function or property output. However, this does not dictate any particular database format or structure for the program's architecture. Beyond the data delivery format and preferably a few further stored procedures, the user-developer is advantageously free to construct and use the preferably software program database as art dictates.

The management of binary objects according to a preferred embodiment is by database stored procedures delivering required data. This is a discipline on the user-developer that is balanced by the freedom to organize the database structure with few limitations. This SQL database-centric development environment may provide an opportunity to integrate other non-object data in ways and means that are highly exploitive of all that a relational database has to offer in efficient data access and manipulation. There is preferably little or no database interface code to write and maintain.

Some advantages of the preferred software architecture briefly include that a substantially unlimited number of binary objects of arbitrary type may be created based on data in a database in accordance with a preferred embodiment. Moreover, functions of open binary objects may be executed, properties of open binary objects may be read or modified, and binary objects may be closed each based on data in the database. Also, a preferred database may be updated with data received from function calls and property access, and an index of volatile pointers may be maintained for opening binary object interfaces so that database data items can reference current open objects by an unchanging name or id number. Also, a simplified, closed operating environment may be maintained wherein binary objects are managed by database data, and database data are delivered to and from the database by database stored procedures.

### ARCHITECTURAL OVERVIEW

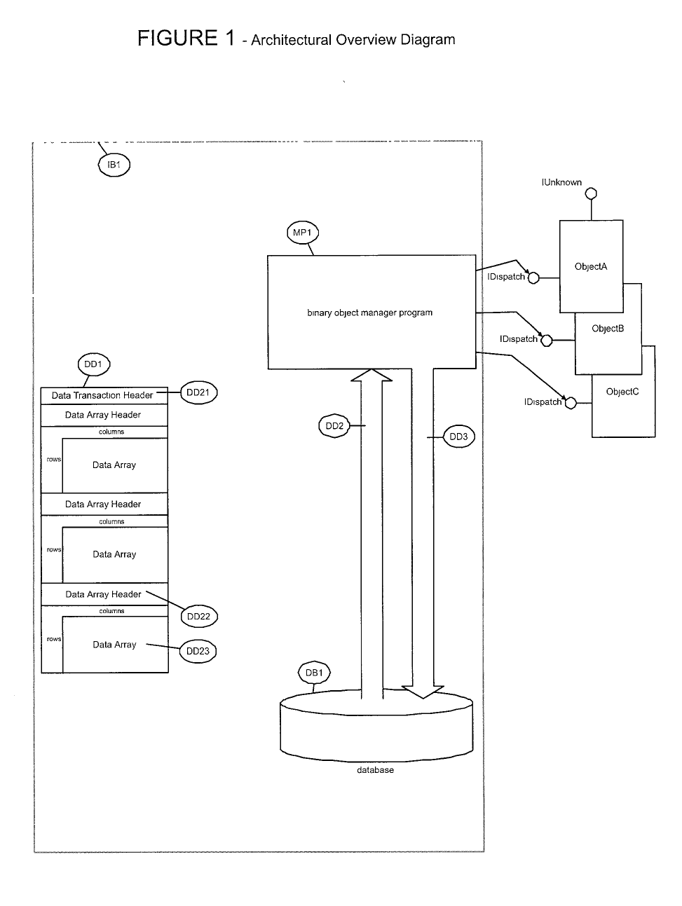

Referring now to FIG. 1, an architectural overview is schematically illustrated according to a preferred embodiment. The preferred software program architecture is schematically illustrated in FIG. 1 within a physical boundary IB1. Outside the boundary IB1 is a depiction of how the architecture within the boundary IB1 can interact with or manage unspecified numbers of binary objects of arbitrary type.

While other configurations are possible, the preferred embodiment includes a binary object manager computer program module MP1 (hereinafter “manager program MP1”) and a database module DB1 (hereinafter “database DB1”) as logical architectural elements with connections depicted by data deliveries DD2 and DD3 over which data movement is in the general format schematically illustrated at DD1. Data delivery depictions DD2 and DD3 represent physical inter-module data movement by a memory-based binary string parameter. The binary string memory area is preferably generated by the operating system and manageable within, but otherwise independent of, the modules MP1 and DB1.

### DATA DELIVERY

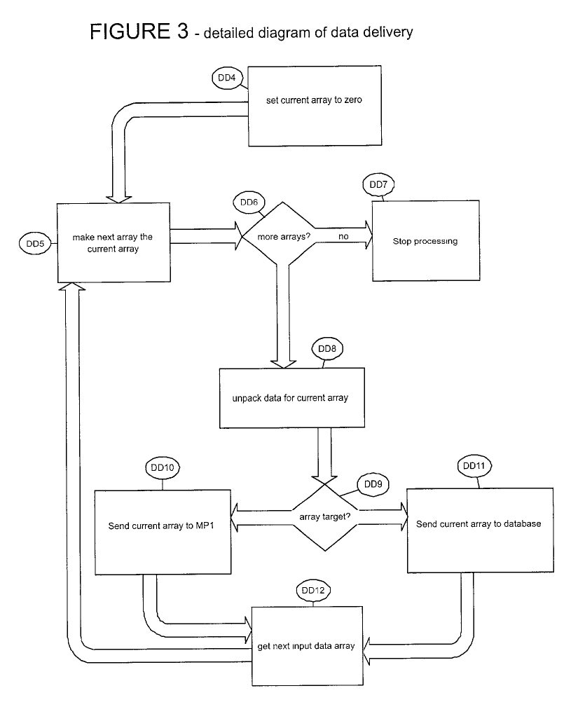

Data delivery according to a preferred software architecture is described generally here, and is described in more detail with reference to FIG. 3, below. In a preferred embodiment, the block depiction of delivered data DD1 in FIG. 1 is a general representation of how the data in a binary string of DD2 and/or DD3 may be organized. Data delivery DD2 from the database DB1, or procedure output, is formed into either managed binary object function calls and property access or calls to other database stored procedures. Data delivery DD3 from the manager program MP1 is SQL syntax database stored procedure executions. Data movement by data delivery DD1 is preferably by binary string with the general format of a transaction header followed by any number of data header/data array pairs, wherein the data arrays may have zero rows and/or zero columns.

The delivered data DD1 includes an overall descriptive header DD21 that includes a count of self-contained data array headers DD22 and corresponding data arrays DD23. Further discussion and depiction may lump the header DD22 and array DD23 pairs together as a single data array. The header DD22 is preferably always present, while the array DD23 itself may have zero length, i.e., zero columns and zero rows. An example of an array DD23 having zero columns and zero rows occurs when the header DD22 identifies a database procedure that has no parameters.

For example, a data delivery header DD22 might contain output from a managed object function call. A developer may thereby update the database DB1 of FIG. 1. A header DD22 may contain data such as any of the following:

execute type=‘P’ (database procedure);

execute name=‘putProp’ (procedure name);

database name=‘browserDOM’;

parameter count=‘1’ (number of DD23 array columns); and,

execution row count=‘1’ (number of DD23 array rows).

Continuing the above example, an array DD23 may contain any of the following:

object identifier=‘text01’;

output value=‘64’; and

output data type=‘14’ (4-byte integer).

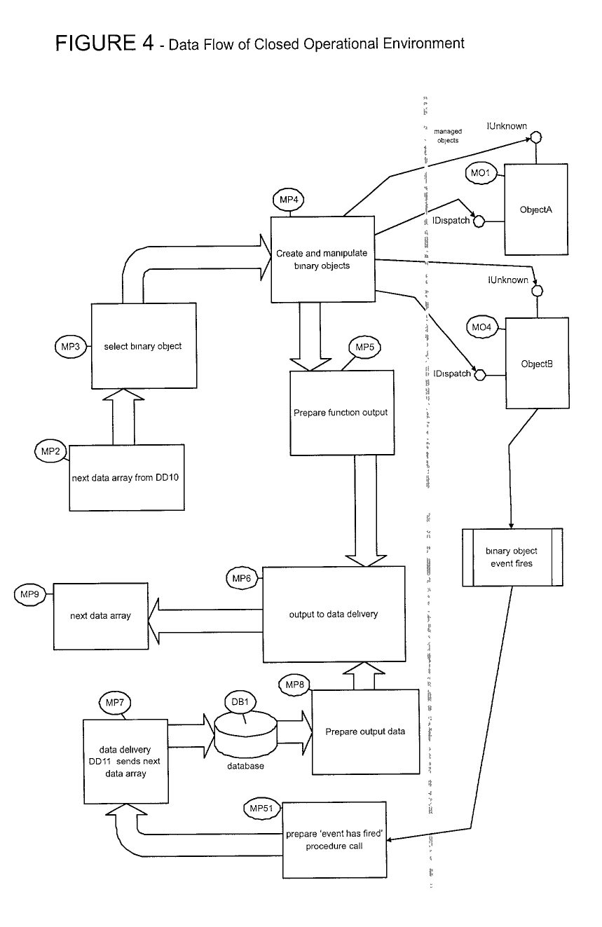

Each preferred data header/array pair DD22, DD23 generally represents a single action to be taken. This single action may initiate follow-on actions (e.g., at operation MP6 as illustrated and described at FIG. 4 and corresponding discussion below). After an action of a current row of the array DD23 (including any follow-on action or actions) is complete, a next row of array DD23 may cause another iteration of this same set of actions but with differing input data. An example of multi-row re-iteration is where the header requests that a binary object function be executed. The rows in the paired data array each may be a separate execution call.

### DATABASE MODULE (DB1)

The database DB1 of FIG. 1 is used to store and retrieve data. The database DB1 may also be directly accessed by stored procedures. Stored procedures are preferably SQL syntax code groupings that are executed as standalone mini-programs. They typically exist as partially-compiled physical entities on the database itself. The partial pre-compilation serves to locate data and pre-configure how the SQL instructions in the procedure will work with this data. In effect, procedure compilation meshes the symbolic SQL with the concrete database data and organization. The database DB1 advantageously has the added versatility of executing database stored procedures in addition to storing and retrieving data.

Program and database construction tools having high versatility as otherwise understood by those skilled in the art may be used to build an architecture such as that which is preferred herein and schematically illustrated at FIG. 1. Therefore, many varied specific approaches to the generally depicted and described preferred embodiment can be used to construct the preferred architecture. According to one example, a raw SQL embedded directly into program code may be used, and in this sense, where the term “stored procedures” is used herein including in the claims, it is meant to include such raw SQL embedded procedures as well as separately stored procedures that may be called from time to time. Use of SQL embedded code instead of a separate database procedure could also result in a different architecture and diagrams then are otherwise described herein. Improved clarity and emphasis on tradeoffs sometimes involved in computer program instruction may lead to alternate construction approaches references and descriptions from time to time.

### BINARY OBJECT MANAGEMENT PROGRAM (MP1)

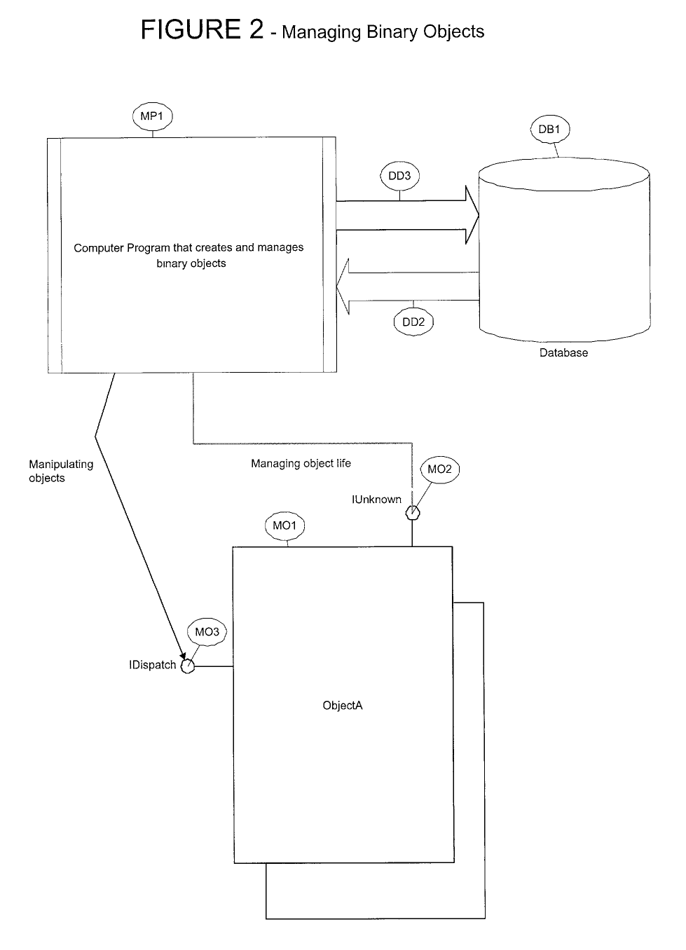

The computer program MP1 of FIG. 1 as an architectural element manages binary objects and may have one or more, and preferably has all, of the capabilities described briefly here. A more detailed description of these capabilities of the manager program MP1 of the preferred architecture illustrated at FIG. 1 is provided with reference to FIGS. 2-7, below.

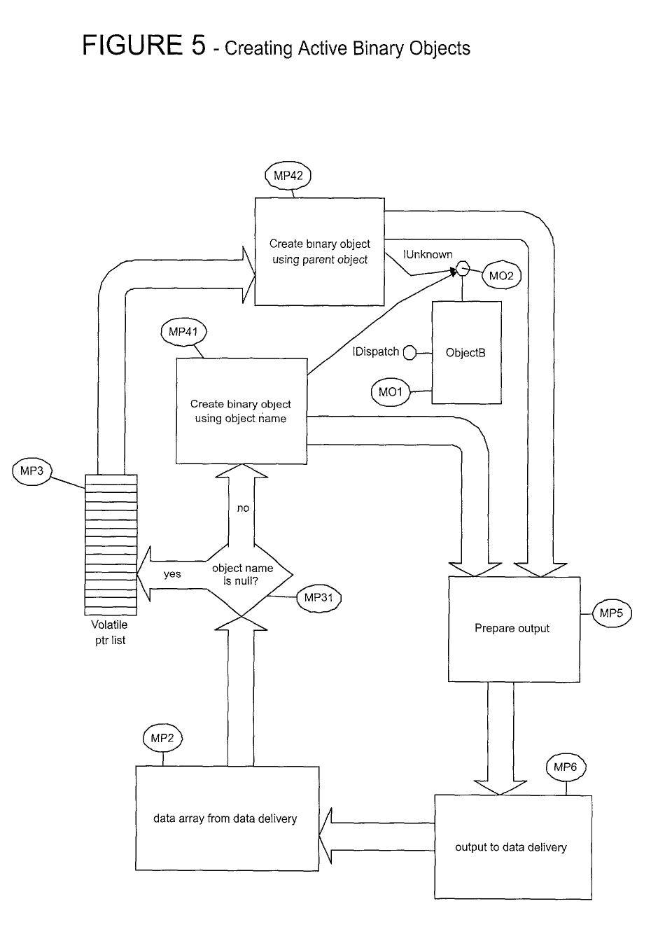

First, the manager program MP1 preferably includes a volatile object pointer list and index lookup (see FIG. 5, element MP3). The volatile object pointer list and index lookup MP3 may be a computer memory-based list of formal object pointers whose location in the list is maintained by the user-developer within the database DB1. The user-developer can reference desired objects by an unchanging name that the computer program turns into an actual instantiation pointer unique to the current computer and program. An alternative software architecture embodiment utilizing the pointer list and index lookup MP3 may include a software program running on one or more outside computers and using the common database DB1 for similar purposes. That is, another object management program running on an outside computer and using the same database DB1, can fully collaborate with or ‘spy’ on the original computer program. This capability is discussed and simulated in the exemplary code provided below.

Second, the manager program MP1 preferably includes binary object creation by name capability (see FIG. 5, element MP41). A binary object will be instantiated (established as viable and ‘live’ in computer memory) before it will be manipulated to serve its innate capabilities. A reference to its exact name allows a computer program to begin the life of that binary object. This capability is also fully demonstrated in the exemplary code provided below.

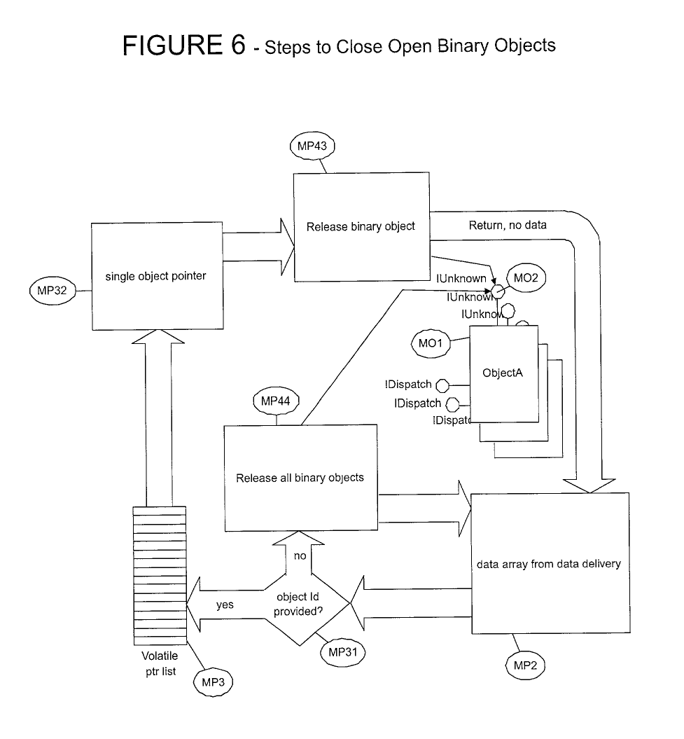

Third, the manager program MP1 preferably includes release (end life) of binary object module (see FIG. 6, elements MP43 and MP44 using whole list). A volatile pointer to a binary object can be directly used to tell the computer to remove this object from its memory, thereby ending its life. This capability is demonstrated in the exemplary code provided below by addressing the managed object directly and using its own ‘Quit’ function to end its life. A raw release of the object pointer, which also ends the object life, is preferably incorporated by using ‘smart’ pointer containers. Smart pointer containers are a feature of some versions of the C++ compiler that may be used to construct the software architecture of FIG. 1.

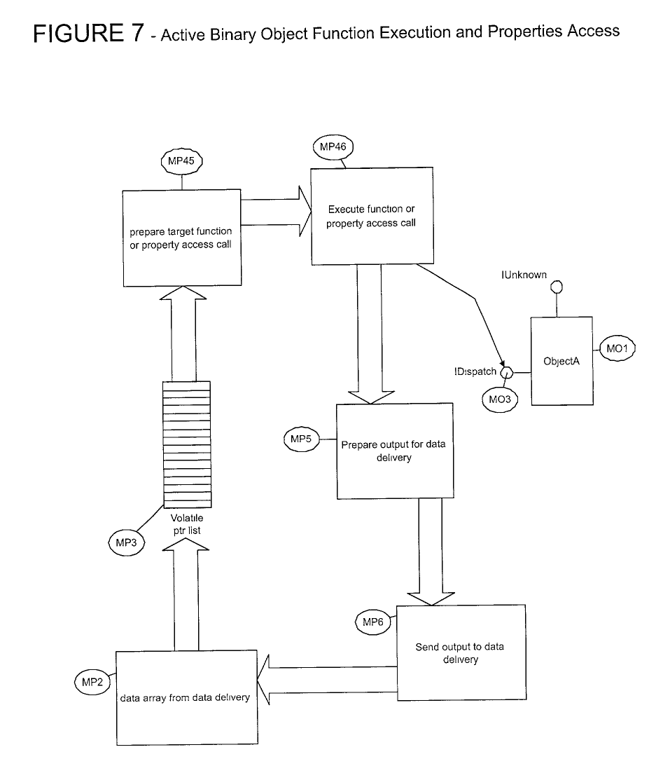

Fourth, the manager program MP1 preferably includes handle invoking function input setup capability (see FIG. 7, element MP45). The ‘invoked’ function (MP46) may have formal input data requirements. Several different uses of the invoker function are demonstrated in the exemplary code provided below.

Fifth, the manager program MP1 preferably includes binary object runtime interface invoking function execution (see FIG. 7, element MP46). Interface-based binary objects may typically have a built-in runtime interface that includes a standard ‘invoking’ function. The invoking function allows the user-developer to parameterize a function or property selection Id along with invoke target parameters. This is a function that invokes the managed object target function or property access. Several different uses of the invoker function are demonstrated in the exemplary code provided below.

Sixth, the manager program MP1 preferably includes handle invoking function output capability (see FIG. 4, element MP5). The ‘invoked’ function (see above and element MP46 of FIG. 7) often has output data to be delivered to further the user-develop design aims. Limited demonstration of handling function output occurs in the exemplary code provided below. An example of object function output is volatile pointers, which may be added to the volatile pointer list in simulation. Other output may be loaded to the database directly by a database procedure call. The standard invoker output is a single data item with a data type indicator; a chore for a database procedure according to a preferred embodiment advantageously to handle.

Seventh, the manager program MP1 preferably includes pack-up data to be delivered (see FIG. 4, element MP5). Data delivery capability according to a preferred embodiment may start with organizing data into a formatted series of headers and two-dimensional arrays, as described above with reference to FIG. 1. The whole data delivery may be a computer memory-based single binary string that is highly optimized for compactness and ease of handling among the various functional areas of the architecture of FIG. 1. The exemplary code provided below includes data as specified constants for ease of demonstration.

Eighth, the manger program MP1 unpacks delivered data (see FIG. 3, element DD8). A series of pertinent data pointers into the data delivery binary string are created so that accessing computer program areas can access the headers and arrays within. Again, the exemplary code provided below includes data as specified constants for ease of demonstration.

Ninth, the manager program MPI includes data delivery capability (see FIG. 1, element DD2 to program, element DD3 to database). Data delivery according to a preferred embodiment involves actual movement of a formatted binary string (e.g., with pack, unpack capabilities) to various functional areas of the software architecture. The binary string is made available using computer memory that the operating system owns. Data movement is by binary string with the general format of a transaction header DD21 followed by any number of pairs of data headers DD22 and data arrays DD23. As mentioned above, the arrays may have zero rows and columns. Areas of the software architecture may work with an operating system to manage the binary string, allowing generally free movement and control to physical and logical areas of the ‘home’ or connected computers across which the preferred software operates. The exemplary code provided below includes data as specified constants for ease of demonstration.

Tenth, the manger program MP1 includes managed object event firing handling capability (see FIG. 4, element MP51). Managed binary objects may support events. Events are the ability to autonomously ‘kick off’ or initiate execution of a prepared computer program area. Objects that have events will generally wait until a specific set of circumstances occurs, and then start up pre-assigned processing. With the preferred software architecture, a developer may select an object and event, prepare a database procedure and add the event to the event list table. The preferred software architecture then supports creation of this object event such that, when fired, the event executes the designated database procedure.

In the description that follows with reference to FIGS. 2-7, various software architecture modules are defined as groups of computer code separated for convenience for illustration. An example of a convenient module might be all direct access code to the database DB1. The binary object manager computer program MP1 and its connection to the database DB1 can be physically coded as several modules. These modules may be flexibly coded subdivisions that may be arbitrarily sub-divided.

### DATA DELIVERY AND STORED DATABASE PROCEDURES

The lingua franca of these preferred embodiments is data delivered to architectural elements as schematically illustrated particularly at FIGS. 2, 3, and 4. This data is created as output from database stored procedures before being presented for execution. The database DB1 preferably contains an SQL syntax parser and SQL-only syntax greatly enhances user-developer efficiency. SQL syntax is advantageously capable of handling the management of binary objects and the database DB1 according to these preferred embodiments.

Architectural elements preferably communicate with each other in a closed operational environment. This means that output of the object manager program MP1 is meaningful to the database and vice versa. This is preferably achieved by first transforming the computer program output into database procedure calls and executing them on the database DB1.

When a computer program is talking to the database DB1, the user-developer uses the database procedure to directly access the database DB1. For computer program output talking to the computer program itself, the database procedure completes the desired round trip by forming the procedure output into a data delivery back to the computer program. That is, the computer program output calls a database procedure that can update the database or execute a managed object function or property access. Likewise, the database DB1 communicates with the program as well as with itself. In the same manner as object function output, database procedures can access and modify the database DB1 directly, produce output for other database procedure calls or include object Id, function or property Id, and parameters meaningful to the computer program.

In contrast to the preferred embodiment, the exemplary code provided below uses a simplified illustrative approach of identifying data items and plugging them in as constants. Both the preferred embodiment and the exemplary code appendix approach result in multiple, arbitrary objects being created, manipulated, and removed as a developer activity. This illustrates that any number of data delivery approaches can be effective.

### MANAGEMENT OF BINARY OBJECTS

FIG. 2 is a logical diagram illustrating the management of interface-based binary objects in accordance with a preferred embodiment. FIG. 2 schematically illustrates a manager program MP1 and database DB1 which communicate with themselves and/or each other through data deliveries DD2, DD3. The preferred manager program MP1 generally creates and manages binary objects. With respect to the preferred database DB1, stored procedure output generally drives user-developer prepared processing. The preferred embodiment is generally described by the main architectural elements MP1 and DB1 in FIGS. 1 and 2. Various instantiations of types of binary objects that may be managed by these main elements MP1 and DB1 are described with reference to FIG. 2.

Referring to FIG. 2, features and characteristics of managed binary objects and their relationship to the software architecture of the preferred embodiment, e.g., how binary objects are used when under the management of the manager program MP1 of FIGS. 1 and 2, are described below. Those skilled in the art understand binary objects, and so a general description of binary objects, other than their relationship under the management of the preferred software architecture, is not set forth here. Authoritative information and binary object details are generally provided by binary object manufacturers relating to their specific binary objects, and binary objects are highly flexible in construction and use, such that various features or characteristics are often optional. An example of an optional feature is a binary object event. Also, while some of what follows is a limited discussion relating to a single managed binary object MO1, the preferred embodiment advantageously has is not limited to a specific maximum number or type of objects it can manage simultaneously.

A managed object MO1 has points of connection to a root pointer MO2 and a runtime interface MO3. The object manager or manager program MP1 may or may not maintain any pointers (see, e.g., description below with reference to element MP3 of FIGS. 4-7) to open active, binary objects. A parent object or other related object may have function or property access that a developer may find adequate and appropriate. An example of when a complete list of object pointers (again, e.g., element MP3 of FIGS. 4-7) may not be necessary would be a multi-object construction where the objects, after instantiation and initial manipulation, have little or no need to be referenced. Instead, the several objects involved may have some affinity to a parent object or other related object that makes reference nevertheless possible, even if indirect. The user-developer using this indirect access can re-establish access and manage the binary object for a particular action, e.g., ending the life of the object.

The root pointer MO2 represents visually at FIG. 2 a point of management of the life of an object MO1. A user-developer may choose a name or parent object for the object MO1. The object manager program MP1 uses this name or the parent object's create function may be executed to create the object MO1. The object MO1 or parent may have a delete function, or the object MO1 may be released by the object manager program MP1.

The object life begins with instantiation of object MO1 as a functioning space in computer memory. The terms active and open may be often used interchangeably with instantiation when memory setup is substantially what brings the binary object MO1 to a state where functions and properties are readily accessible and able to act on their full set of features and characteristics. That is, instantiation often includes making binary objects, such as object MO1 of FIG. 2, open and active. The preferred architectural manager program MP1 and database DB1 permit the user-developer to manage those steps that make the specific type of binary object fully operational.

As briefly referred to above, the root pointer MO2 is also used to represent the management of the end of the life of the managed binary object MO1. As a developer deems appropriate, the binary object manager program MP1 can use the name, volatile pointer index, and/or object pointer of a parent or other object to end the life of a designated binary object, e.g., object MO1. A capability to end the life of binary object MO1 is an advantageous feature of the preferred software architecture to the user-developer, because the instantiated binary object MOI will otherwise occupy computer memory, which is a finite resource.

A connection of the binary object MO1 to the runtime interface MO3 is generally where object functions and properties are executed and accessed. A user-developer may choose a function or property Id for the object MO1 with the preferred runtime interface MO3. A user-developer may choose an event-establishing function. Events may be handled as functions with executions delayed until the event has triggered. The object-specific event firing may result in a developer-prepared database procedure call. With the help of a volatile object pointer, this interface MO3 provides function execution and property access for the desired object MO1 as a standardized capability, advantageously providing an ability to readily manage many numbers and/or types of binary objects. Further features and uses of the runtime interface MO3 are provided below with reference to FIG. 7.

### MANAGING BINARY OBJECT EVENTS

As mentioned above, an optional and advantageous feature of interfaced-based binary objects that use the runtime interface MO3 in accordance with a preferred embodiment is the ability to manage binary object events. Interfaced-based binary objects, such as object MO1 of FIG. 2, often have the ability to cause executions because some anticipated activity involving the object MO1 has occurred. Each type of object MO1 will have its own event setup and firing mechanisms. These mechanisms follow a general pattern of a property that represents a specific managed object event being updated to point to object manager physical computer code. In a preferred embodiment, a pointed-to physical code executes a database procedure whose name has been linked to this object's specific event.

User-developer setup efforts may include function executions and property setups that establish the event on binary objects. Event setup may also include creating data items and the event-firing of a stored procedure on the database DB1. The developer may also build the event database procedure. Preferably, this capability is limited to a standardized, fixed set of parameters that are automatically prepared by the binary object manager program MP1.

A closed operating environment according to a preferred embodiment, as described below with reference to FIG. 4, asynchronously executes an event target database procedure when an event fires. A managed object may or may not be included within a same computer process memory as the preferred architectural components MP1 and DB1 of the preferred embodiment invention, i.e., a managed binary object may be prepared and installed as one or the other. In-process objects deliver event notice by accessing generic processing areas as a direct call to a function of a program components MP1, DB1. Managed binary objects that are external to the computer process memory direct their event notice by way of the runtime interface MO3 of FIG. 2. The preferred embodiment is advantageously capable of handling both approaches, i.e., objects may be located on any available and accessible object-capable computer. Exact details on event notice delivery for in-process and out-of-process objects are typically manufacturer-specific, and authoritative information is typically published. The exemplary code provided below does not specifically demonstrate event delivery.

### DATA DELIVERY MODULE

FIG. 3 is a detailed diagram illustrating data delivery among architectural elements and their functional areas in accordance with a preferred embodiment. The data delivery module handles data delivery for the preferred software architecture. The data delivery module may be a module included within one or both of the manager program module MP1 and database module DB1 of FIGS. 1 and 2, or the data delivery module may be a separately stored component of the preferred software architecture. Any of these alternatives would be more definitional then substantive and would be within the scope of the present invention as set forth in the claims below, notwithstanding whether the data delivery module is recited as a separate module or as being part of MP1 and/or DB1. Data delivery in the preferred embodiment occurs when specifically formatted data, after packaging into a single contiguous computer memory area (i.e., a binary string), is placed on a computer system resource that can move preferably without substantial restriction across most intra-computer and inter-computer boundaries. The binary string is then moved to another processing area, is unpackaged, and is made available to process activities from there.

Modern computers and their infrastructure software have advantages with their ability to distribute functional capabilities into separate areas both on the same computer as well as on other, connected computers. Interface-based binary objects according to the preferred embodiment are in the distribution forefront as they can preferably be located in any of these locations.

Data delivery according to a preferred embodiment permits the logical and/or physical distribution of data relating to binary objects to functional areas efficiently and accurately. The modular distribution of the preferred software architecture is preferably selected to promote efficiency and performance. The most desirable modular complement and location allocation are possible due to the versatility of the data delivery module of the preferred embodiment. For example, the “data delivery module”, i.e., of the preferred embodiment as well as in the claims, may be part of the manager program MP1 or the database DB1 or both, or may be stored as a separate module, or may be partially separately stored while having components within the manager program MP1 or the database DB1 or both.

To better service the computer program areas that use data delivery in accordance with a preferred embodiment, optimized operational characteristics are synergistically included from the areas involved. An example of this synergy is a two-dimensional array DD23 for efficient database data access that is also optimal for the object manager program MP1 when preparing and executing a managed object runtime interface invoking function.

Another characteristic of preferred data delivery is predictable sequencing of data delivery processing that is physically unaffected by other, perhaps similar and/or simultaneously executing activities. A user-developer benefits from the capability of the preferred software architecture to handle asynchronous interruption of existing, on-going data delivery with other data delivery or deliveries. This capability handles managed binary object events that can occur at any time. Data storage and procedure execution in the database DB1 for multiple, simultaneous data delivery may be handled by currently available high-performance SQL database software.

Each iteration of a preferred data delivery is unique and works with unique data. This allows iteration to overlap. For example, iteration 1 may cause iteration 2 to begin while iteration 1 is still in progress. This overlapping architecture according to a preferred software architecture is permitted for an arbitrary number of iterations as long as the underlying computer's execution capabilities are not exceeded. The user-developer may implement data deliveries to stand along or overlap, as desired. The developer's design is implemented by executing database stored procedures of the preferred embodiment. An overlapping iteration occurs whenever a database procedure output includes an execution that itself has output to be processed. An iteration can explicitly not overlap another iteration by separating data delivery execution requests that cause each iteration into their own binary string transport arrays. The array may be in the same or another delivered binary string an example of the use of a non-overlapped iteration may be at the very beginning when a binary object is first created before any manipulation can occur.

Referring now specifically to FIG. 3, a data delivery begins with an arrival of a formatted binary string DD4 (equivalent to DD1 of FIG. 1) containing headers DD21, DD22 and data arrays DD23. At DD4, data delivery is received and a current array is set to zero. Processing continues as the first or next data array becomes the current target at DD5. A qualifying process at DD6 determines whether all data arrays have been handled. If there are not more arrays, then processing is stopped or data delivery is completed at DD7. If, however, there are more data arrays, then the next step is to unpack the next data array at DD8. In generally, unpacking involves a creation of pointers into the data array so that pertinent information such as destination target, field count, current field location, etc., are made available.

At DD9, the data delivery destination target is checked for making preparing the data for delivery to the manager program MP1 from DD10 or for preparing the data for delivery to the database module DB1 from DD11. Note that further descriptions of actions of the manager program MP1 based on this data are set forth above and below with reference to FIGS. 1 and 5-7 including binary string handling, object creation, object closing and object function execution and properties access calls, respectively. Database delivery data is preferably at least substantially always a procedure, which is executed. Database delivery actions are described further beginning at MP7 in FIG. 4.

A data array passed through either of DD10 and DD11 of the data delivery module illustrated at FIG. 3 to the manager program MPI or database DB1, respectively, may generate output which is completely processed at the destination (see element MP6 of FIGS. 4, 5 and 7 and corresponding description below). Preferably, no data is returned from these destinations back to DD10 and DD11. Resumption of a next array data delivery follows DD10 and DD11 through DD12 back to DD5. At DD12, data delivery is complete for the current input array and the next task is to get the next array, and to make the next array the current array at DD5. This completes the loop back to where a next data array from the original input delivery is sought at DD5 and processed starting at DD8, or when delivery formally completes at DD7.

The object manager program MP1 and database DB1 receive data from and send data to points DD10 and DD11 of the data delivery module, respectively, in FIG. 3, and process their own output. Return of data from DD10 and DD11 occurs after data handling completion. Stepping from DD10 to DD12 and from DD11 to DD12 in FIG. 3 preferably does not include any data movement. These steps show that original input data processing picks up at DD12 and continues.

### CLOSED OPERATIONAL ENVIROMENT

FIG. 4 is a data flow diagram illustrating a closed operational environment for a manager program (MP1) data flow of the software architecture according to a preferred embodiment. The term closed is descriptive in that a user-developer of a software architecture according to a preferred embodiment is preferably limited to managing a database DB1, setting up appropriate data in that database DB1, constructing database stored procedures that collect, organize, distribute and direct data delivery to destinations using appropriate data format and delivery mechanisms, working with a limited number of architectural elements (e.g., DB1, MP1, and perhaps a data delivery module) which communicate only with themselves and each other, and using SQL syntax. The data delivery format is preferably pre-determined but the contents will depend on the type of binary object being managed and what the desired outcome of the user-developer's endeavors are.

FIG. 4 follows data movement from where each data array becomes a segment of the memory-based binary string that makes up a complete data delivery. Description of segmentation details are described in more detail above with reference to FIG. 3. As also discussed above with reference to FIG. 1, a data delivery segment preferably a data header/data array pair (DD22, DD23) which generally represents a single action to be taken. In the preferred embodiment, the data delivery source and destination may be either the binary object management computer program MP1 or the database DB1. In either case, the single action to be taken is preferably completed at MP6 of FIG. 4, including any follow-on actions, before the data delivery flow returns or unwinds back to the original binary string segment source at MP9 and tackles the next segment.

There are several reasons why a data delivery typically occurs. These include, but are not necessarily limited to: an initial, bootstrap database procedure call occurs and provides output to handle, other on-going activities such as database stored procedure calls, execution of managed binary object functions and access to managed binary object properties provide output, and/or managed binary object events explicitly established during creation and manipulation of the binary object result in output to be processed. An example illustrating these data delivery activators working together is the occurrence of a bootstrap call when the object manager program MP1 starts up on a computer. The bootstrap includes some binary object instantiations. The processing continues with managed object manipulations including creation of some events that fire when data is entered on the screen, select options are made or buttons are pushed. The operating scenario may then pause until some data is keyed in, an option is selected or a button is pushed and the event is fired. A result of an event firing according to a preferred embodiment is the immediate execution of a prepared database procedure. The procedure execution provides output that causes continuation into several other connected activities. Finally, for scenario symmetry, at some later time there is another event whose circumstances are met. The event fires and ends the life of the managed binary object.

Referring now generally to FIG. 4, the object management computer program MP1 has a data flow beginning point at MP2. Data flow to the database DB1 begins at MP7, continuing through database access and procedure output handling at MP8. Database and computer program data flow together for common output handling occurs at MP6 before separating again to DD10 and DD11 of a data delivery module (see FIG. 3 and description above), where the original data delivery seeks a next data array for processing.

More particularly, data delivery to the binary object manager program MP1 begins at MP2, i.e., where a data delivery module sends a next data array to the manager program MP1. The data arriving at MP2 flows on to the volatile object pointer list MP3 where the volatile object pointer index is used to select a binary object to reference. The volatile object pointer index is preferred for data delivery using the object manager computer program MP1. The index is turned into the pointer for the appropriate managed binary object. Other data delivery inclusions for the computer program make it possible to manage the life or manipulate an instantiated binary object at MP4. The output from a MP4 activity is formatted at MP5 into a database procedure call. At MP5, function output data is prepared for data delivery. Setup data array or arrays identify the object manager program MP1 or the database DB1 as a target destination.

At MP6, output is sent to a new iteration of data delivery (e.g., at DD4, and where DD7 returns to MP6, see FIG. 3 and description above). MP6 handles this output. Computer program returns include stepping from MP6 to MP2 or from MP6 to MP7. From MP6 to MP9, a return to original data delivery iteration occurs including a return to data array sender (DD10 or DD111 of FIG. 3, above), where the data flow ends.

Data delivery to the database program DB1 begins at MP7 in FIG. 4, i.e., where a data delivery module sends a next data array to the database module DB1. From the data delivery at MP7 to the database DB1 as a target destination, a database procedure is executed on the database DB1 for appropriately formatting the output data at MP8. Data arrays are then setup for identifying either the object manager program MP1 or the database DB1 itself as the target destination. That is, database procedures may generate output data for delivery to the object manager computer program MP1 or the database DB1. From MP8, output is sent to a new iteration of data delivery at MP6.

The data flow from the architectural elements MP1 and DB1, after formatting at MP5 and MP8, respectively, moves to a common creation of a data delivery at MP6. Referring back to the original data delivery entry points MP2 and MP7 of FIG. 4, data flow into data delivery MP6 is a separate data delivery iteration that is preferably completed prior to moving on to the input iteration return steps MP6 to MP9 to DD10 of the data delivery module of FIG. 3 (see above), when original input was to the object manager program MP1, or MP6 to MP9 to DD11 of the data delivery module of FIG. 3 (again, see above), when the database DB1 was the original destination.

A user-developer can also set up an event on a managed binary object MO4 by calling a ‘createEvent’ function, which includes telling the object MO4 to send event fire notice to module MP51 of the preferred software architecture. The module MP51 then prepares an event has fired database procedure call. The data delivery proceeds then to module MP7 when data delivery DD11 of the data delivery module of FIG. 3 sends a next data array. The developer prepares information such as object Id, event type and database procedure name in a database object event list. The format for the event create function is preferably fixed, and the data values and database structures and source or sources are preferably configured by the developer. When the object MO4 and an event-specific set of circumstances occurs, the managed object MO4 will contact the manager program MP1 at module MP51 for a standard event database procedure call for data delivery to MP7. The event database delivery is similar to the delivery DD2, DD3 between the architectural elements MP1 and DB1 of the preferred software architecture, described above with reference to FIG. 1. This database procedure handles events by selecting from the database DB1 the specific object and event follow-on actions such as executing the database procedure stored with this event. Database procedure output handling (MP8 to MP6 to MP9) then proceeds according to the above.

### ACTIVE BINARY OBJECT CREATION

FIG. 5 is a detailed diagram delineating creation of an active binary object MO1, e.g., in accordance with a preferred embodiment. The entry and exit point is MP2, just as described with reference to FIG. 4 above for the manager program MP1. A data delivery data array segment is received at MP2 having data sufficient to instantiate a specific binary object to be managed by the preferred software architecture. The data delivery iteration for this data array expects all output data to be handled as soon as it is generated by a MP6 delivery iteration or iterations. Completion of object instantiation is signaled by a no-data step that returns through the entry/exit point MP2 so that processing of a next data array segment in the original input point MP2 can be returned from DD10 of FIG. 3.

After receipt at MP2 of a data array from the data delivery module at DD10 of FIG. 3, at MP31, create-object data delivery according to a preferred embodiment comes as either a binary object name so that the data delivery flow continues to point MP41 for creation of the binary object by using the object name, or an existing volatile object pointer index value so that the data delivery continues to index-driven lookup MP3. As mentioned above, the volatile pointer list MP3 selects the binary object to reference. The looked-up object pointer from MP3 becomes the source for function execution to occur at MP42, which creates the desired object MO1 using a parent object from the root pointer MO2. From either of MP42 or MP41, the data delivery process is continued at MP5 by preparing output for data delivery and at MP6 by sending output to a new iteration of data delivery (e.g., DD4 of FIG. 3). That is, output from creation of a binary object MO1 using the preferred software architecture at MP41 and/or MP42 is formed into the database procedure at MP5 and then processed by separate data delivery iteration at MP6. After output data delivery is complete at MP6, there is a return back through the entry/exit to DD10 (see FIG. 3) for processing of the next data array of the original input iteration.

Exact usage depends on the type of binary objects involved as parent or other object resource and instantiation targets. The user-developer may preferably determine the driving input data. Of the two, instantiating a named binary object at MP41 is more straightforward. The name is used directly by the object manager computer program MPI at root pointer MO2 to create object MO1. Other information, such as whether the object instantiation is or is not within the computer process memory that also contains the manager program MP1 and database DB1, as discussed above, may be included.

The object MO1 may be a depiction of a generic stand-in managed object resulting from the preferred software architecture at work and is not part of the software architecture itself. The specific objects created are determined by the user-developers.

### CLOSING AN OPEN BINARY OBJECT

FIG. 6 is a detailed diagram illustrating the closing of open binary objects in accordance with a preferred embodiment. That is, FIG. 6 illustrates how the life of a managed binary object may be brought to an end using a software architecture according to a preferred embodiment. A managed binary object MO1 may represent an object that currently exists. The arrival of data at the entry/exit point MP2 begins the process. Recall that MP2 is the point at which a data array may be received by the manager program MP1 from the data delivery module of FIG. 3 at DD10, or MP2 is the point from which data may be returned by the manager program MP1 to the data delivery module when processing is complete, or alternatively, no data may be returned. The data arriving at MP2 may include information such as an object Id, or index into the volatile object pointer list, regarding an existing target object MO1. When such object Id information is not included, as determined at MP31, all open binary objects are the targets with processing by the object manager computer program MP1 at MP44 which will reference preferably all volatile object pointer indexes at root pointer MO2. A no-data return will then move the process back to MP2. If the detection process at MP31 finds an index into the volatile pointer list MP3, such as when object Id information is provided, then the particularly identified binary object pointer MP32 is used to end the life of the binary object MO1 at MP43 by releasing the designated binary object at root pointer MO2. Both processing paths make a no-data return back through the original data delivery entry/exit point MP2, so that further processing there may continue.

An alternative for ending the lives of some binary objects was briefly mentioned above with reference to FIG. 2 and root pointer MO2. That is, a user-developer may arrange a removal function call or calls for certain objects. The object or its parent may have its own delete function. General handling of object functions is described below with reference to FIG. 7. In general, object release is preferably handled through the manager program MP1.

### OBJECT FUNCTIONS

FIG. 7 is a diagram that illustrates the execution of binary object functions and reading or modifying properties in accordance with a preferred embodiment. FIG. 7 illustrates how the preferred software architecture may be used to execute managed binary object functions and access their properties. A data array received at MP2 includes data such as a binary object index or indexes, a function or property Id value or values and their parameter or parameters. The specific contents may be determined by the user-developer. Among the data array items provided at MP2 is an index to a target binary object MO1 where the function is to be executed or the property accessed. This index is used at MP3 to find the object's volatile pointer. At MP45, delivered data is used to prepare a target function or property access call.

Data delivered as input and handled at MP45 may include binary object Id, function Id, property Id and/or one or more parameters. The binary object Id provides an index into the volatile object pointer list. The function Id or property Id may have a value that, for this type of object, uniquely identifies which function to execute or which property to access through an invoking function of the runtime interface MO3 (see FIGS. 2 and 6). Parameters may include zero or one or more values that match requirements of the function Id or property Id. Number values and their data type are matched to these function or property requirements. A user or developer may choose from a binary object documentation list.

After input is prepared at MP45, an invoking function of the runtime interface MO3 is executed at MP46. MP46 is where the desired binary object function is executed and property access call occurs by invoking a binary object runtime interface function. The capabilities of an interface-based binary object MO1 include a runtime interface MO3 that supports a function or function, which may be preferably standardized, with a fixed set of parameters that invokes object-specific functions and accesses object-specific properties. It is a function that calls other functions.

The fixed, common set of parameters for the preferred runtime interface invoking function MP46 turns the delivered data into a desired or selected function call or property access by a user-developer. Depicted at MO1 of FIG. 7 is a binary object a whose volatile pointer is used to access the runtime invoking function. At the runtime interface MO3, the target Id is slotted into the invoking function call along with any binary object function or property parameters.

The invoking function is executed MP46 which in turn executes the binary object's function or accesses a property. The runtime interface pointer MO3 may be used to execute an interface-only invoker function that invokes a user or developer-chosen target function or property access. That is, a fixed function, which may be standardized, that has both function selection parameters as well as the real parameters of the selected function. The invoker function does the desired execution or access and returns output.

The resulting output from this standard invoking function call is appropriate for computer program processing at MP5 according to the above description. This preparation at MP5 becomes the input to a data delivery at MP6 that processes what is in this delivery. Note that runtime invocation output formats and techniques may vary. Upon completion, a no-data return passes through MP6 and MP2 back to the original delivery iteration at DD10 of FIG. 3 for further processing of any further data arrays there. Any further original input results in a data array delivery back to MP2 and the depicted steps of FIG. 7 may be repeated.

### Exemplary Code

The exemplary code referred to above is provided below in accordance with a preferred embodiment:

// bomgr.cpp : Defines the entry point for the application.
//
#include “ie6.h”
int APIENTRY WinMain(HINSTANCE hInstance,

| HINSTANCE hPrevInstance, | |
|---|---|
| LPSTR | lpCmdLine, |
| int | nCmdShow) |

{

ie6 *pIE6 = new ie6( );// ie6.cpp, ie6.h
pIE6->StartIE6( );
return 0;

}
// ie6.cpp: implementation of the ie6 class.
//

/*
The following code is provided to meet the ‘teaching’ requirement
of an invention. That is, helping a software engineer to construct
workable code that demonstrates the invention at work. This invention
is an interface between a database (providing a data repository
and executing prepared SQL procedures) and the managed binary objects.
The invention purposely makes the managed object complement and the
database external to the invention. The demonstration binary
objects are arbitrary: Microsoft's internet explorer in the form of
binary objects. Likewise, the demonstration code shows what data
is required and how it is used to manage the arbitrarily-chosen
binary objects. The code to move data to and from the database
is available from any number of published sources.
An example of code that is necessarily simplified is simulation of
database-provided data. The data is coded as constants so that
database access is not required.
Another simplification is the setup and use of the volatile object
pointer list. Only a few objects are created and managed in this
example, making a robust, variable entry count coding effort
inappropriate.
The execution code for handling events fired in the created binary object
internet explorer requires, by its nature, a much more complex example
program. Event handling is beyond the scope of this teaching example
of the invention code. Such example code is published in numerous places.
The code was prepared using Microsoft's Visual Studio. However, all known
compile complexity was removed. Plain C++ compiles using other approaches
should be possible with little adjustment. Generic COM headers and code
are the only non-basic Microsoft Windows inclusions.
*/

/////////////////////////////////////////////////////////////////////
#include “ie6.h”
/////////////////////////////////////////////////////////////////////
// Construction/Destruction
/////////////////////////////////////////////////////////////////////
ie6::ie6( )
{

IHTMLDocument2 *d2 = NULL;
progend = 0;
CoInitialize (NULL);

}
ie6::˜ie6( )
{

CoUninitialize( );

}
HRESULT ie6::StartIE6( )
{

| HRESULT hr; | |
|---|---|
| DISPPARAMS | dp, diapparamsNoArgs = {NULL, NULL, 0, 0}; |
| VARIANTARG | VarResult, *pVarResult; |

UINT argerrnum = 99;
long dval = 0;
DISPID dispidNamed = DISPID_PROPERTYPUT;
// reference FIG. 4
LPOLESTR // MP2 − simulation of DB-provided data

wb2clsid = L“{0002DF01-0000-0000-C000-

000000000046}”, //CLSID_InternetExplorer

wb2iid = L“{00020400-0000-0000-C000-000000000046}”;//IDispatch

| // setup for MP41 − turn CLSID string into real CLSID | |
|---|---|
| CLSID clsidwb2; | // standard, non-specific object pointer |

hr = CLSIDFromString(wb2clsid, //Ptr to string representation of CLSID

| | |
|---|---|
| &clsidwb2 | //Pointer to the requested CLSID on |

return

};

| // setup for MP41 - turn IID into real IID | |
|---|---|
| IID iidwb2; | // standard, non-specific object pointer |

hr = IIDFromString(wb2iid, //Pointer to string representation of IID

| | |
|---|---|
| &iidwb2 | //Pointer to the requested IID on return |

};

// MP41 - use string-to-ptr parameters to create desired (uninitialized) object
hr = CoCreateInstance(clsidwb2, NULL, CLSCTX_SERVER,

iidwb2, (LPVOID*) &pDisp);

// with internet explorer (ie), all other objects are created using other
// object pointers (FIG. 4, MP42)
// initialize and use the name-generated ie object
if (pDisp)
{

| pVarResult = &VarResult; | |
|---|---|
| VariantInit (pVarResult); | |
| // MP2 - data delivery simulation | |
| // MP43 - prepare for invoker | |
| long Visible = 402; | |
| dp.rgvarg = new VARIANTARG[1]; | |
| dp.rgdispidNamedArgs = &dispidNamed;// Dispatch IDs of named arguments. | |
| dp.cArgs = 1; | // Number of arguments. |
| dp.cNamedArgs = 1; | // Number of named arguments. |

| dp.rgvarg[0].vt = VT_BOOL; | |
|---|---|
| dp.rgvarg[0].boolVal = −1; | //true |

// MP46 - runtime interface invoker
// initializes the name-prepared object (becomes visible)
hr = pDisp->Invoke(Visible, IID_NULL, LOCALE_USER_DEFAULT,

DISPATCH_PROPERTYPUT, &dp, pVarResult, NULL,

&argerrnum );

| delete dp.rgvarg; | |
|---|---|
| // MP2 - data delivery simulation | |
| // MP43 - prepare for invoker | |
| long GoHome = 102; | |
| dp.rgdispidNamedArgs = NULL; | // Dispatch IDs of named arguments. |

| | |
|---|---|
| dp.cArgs = 0; | // Number of arguments. |
| dp.cNamedArgs = 0; | // Number of named arguments. |

// MP46 - runtime interface invoker
// completes initialization (first page)
hr = pDisp->Invoke(GoHome, IID_NULL, LOCALE_USER_DEFAULT,

DISPATCH_METHOD, &dp, pVarResult, NULL, &argerrnum

};

| // wait a few seconds for Home navigation to complete | |
|---|---|
| // another option (more code) is to wait for a complete event | |
| HANDLE hTimer = NULL; | |
| LARGE_INTEGER liDueTime; | |
| BOOL setm; | |
| DWORD waitm; | |
| liDueTime.QuadPart=−100000000;// 10 seconds | |
| hTimer = CreateWaitableTimer(NULL, TRUE, “WaitableTimer”); | |
| setm = SetWaitableTimer(hTimer, &liDueTime, 0, NULL, NULL, 0); | |
| waitm = WaitForSingleObject(hTimer, INFINITE);// != WAIT_OBJECT_0) | |
| // this won't work right until GoHome( ) has completed | |
| // MP2 - data delivery simulation | |
| // MP43 - prepare for invoker | |
| long Navigate = 104; | |
| _bstr_t wnm(L“nytimesmain”); | |
| dp.rgvarg = new VARIANTARG[5]; | |
| dp.rgdispidNamedArgs = NULL; | // Dispatch IDs of named arguments. |

| | |
|---|---|
| dp.cArgs = 5; | // Number of arguments. |
| dp.cNamedArgs = 0; | // Number of named arguments. |

| dp.rgvarg[4].vt = VT_BSTR; | // params loaded in reverse order |
|---|---|
| _bstr_t dev1(L“about:develop1”); | |
| dp.rgvarg[4].bstrVal = dev1; | |
| dp.rgvarg[3].vt = VT_UI1; | // flags |
| dp.rgvarg[3].bVal = 0x00; | |
| dp.rgvarg[2].vt = VT_BSTR; | // window name |

// name of home window (changes when home page is modified)
// it is possible for developer to query run obj functions for name (more

code)

| dp.rgvarg[2].bstrVal = wnm; | |
|---|---|
| dp.rgvarg[1].vt = VT_UI1 \| VT_UI1;// ignored | |
| dp.rgvarg[0].vt = VT_BSTR; | // ignored |

_bstr_t miss (L“”);
dp.rgvarg[0].bstrVal = miss;
// MP46 - runtime interface invoker
// move to a (mostly) blank page
hr = pDisp->Invoke(Navigate, IID_NULL, LOCALE_USER_DEFAULT,

DISPATCH_METHOD, &dp, pVarResult, NULL, &argerrnum

};

| delete dp.rgvarg; | |
|---|---|
| // MP2 - data delivery simulation | |
| // MP43 - prepare for invoker | |
| long Document = 203; | |
| dp.rgdispidNamedArgs = NULL; | // Dispatch IDs of named arguments. |

| | |
|---|---|
| dp.cArgs = 0; | // Number of arguments. |
| dp.cNamedArgs = 0; | // Number of named arguments. |

// MP46 - runtime interface invoker
// retrieve existing object pointer from parent object
hr = pDisp->Invoke(Document, IID_NULL, LOCALE_USER_DEFAULT,

DISPATCH_PROPERTYGET, &dispparamsNoArgs, pVarResult, NULL,

&argerrnum );

| // MP5 - prepare output for date delivery | |
|---|---|
| // MP6 - data delivery (simulated) | |
| pDisp1 = pVarResult->pdispVal; | // store doc obj ptr in simulated ptr |

list

| VariantInit (pVarResult); | |
|---|---|
| // MP2 - date delivery simulation | |
| // MP41 - create another object from an existing pointer | |
| long createElement = 1067; | |
| dp.rgvarg = new VARIANTARG[1]; | |
| dp.rgdispidNamedArgs = NULL; | // Dispatch IDs of named arguments. |

| | |
|---|---|
| dp.cArgs = 1; | // Number of arguments. |
| dp.cNamedArgs = 0; | // Number of named arguments. |
| dp.rgvarg[0].vt = VT_BSTR; | |
| _bstr_t textbox(L“INPUT”); | |

| | |
|---|---|
| dp.rgvarg[0].bstrVal = textbox; | // create text box object |

hr = pDisp1->Invoke(createElement, IID_NULL, LOCALE_USER_DEFAULT,

DISPATCH_METHOD, &dp, pVarResult, NULL, &argerrnum

};

| delete dp.rgvarg; | |
|---|---|
| // MP5 - prepare output for data delivery | |
| // MP6 - data delivery (simulated) | |
| pDisp2 = pVarResult->pdispVal; | // store text obj ptr in simulated |

ptr list

| VariantInit (pVarResult); | |
|---|---|
| // MP46 - runtime interface invoker | |
| // retrieve existing object pointer from parent object | |
| long body = 1004; | |
| dp.rgdispidNamedArgs = NULL; | // Dispatch IDs of named arguments. |

| | |
|---|---|
| dp.cArgs = 0; | // Number of arguments. |
| dp.cNamedArgs = 0; | // Number of named arguments. |

// MP46 - runtime interface invoker
// retrieve existing object pointer from parent object
hr = pDisp1->Invoke(body, IID_NULL, LOCALE_USER_DEFAULT,

DISPATCH_PROPERTYGET, &dispparamsNoArgs, pVarResult, NULL,

&argerrnum );

| // MP5 - prepare output for data delivery | |
|---|---|
| // MP6 - data delivery (simulated) | |
| pDisp3 = pVarResult->pdispVal; | // store body object in simulated ptr |

list

| VariantInit (pVarResult); | |
|---|---|
| // MP2 - data delivery simulation | |
| // MP43 - prepare for invoker | |
| long appendChild = −2147417039; | |
| dp.rgvarg = new VARIANTARG[1]; | |
| dp.rgdispidNamedArgs = NULL; | // Dispatch IDs of named arguments. |

| | |
|---|---|
| dp.cArgs = 1; | // Number of arguments. |
| dp.cNamedArgs = 0; | // Number of named arguments. |
| dp.rgvarg[0].vt = VT_DISPATCH; | |

| | |
|---|---|
| dp.rgvarg[0].pdispVal = pDisp2; | // append text box object to body |

node

// MP46 - runtime interface invoker
// cause a newly created object to become visible
hr = pDisp3->Invoke(appendChild, IID_NULL, LOCALE_USER_DEFAULT,

DISPATCH_METHOD, &dp, pVarResult, NULL, &argerrnum

};

| delete dp.rgvarg; | |
|---|---|
| VariantInit (pVarResult); | |
| // MP2 - data delivery simulation | |
| // MP41 - create another object from an existing pointer | |
| long createTextNode = 1074; | |
| dp.rgvarg = new VARIANTARG[1]; | |
| dp.rgdispidNamedArgs = NULL; | // Dispatch IDs of named arguments. |

| | |
|---|---|
| dp.cArgs = 1; | // Number of arguments. |
| dp.cNamedArgs = 0; | // Number of named arguments. |

dp.rgvarg[0].vt = VT_BSTR;
_bstr_t textnode(L“textnode”);
dp.rgvarg[0].bstrVal = textnode;// create textnode object
hr = pDisp1->Invoke(createTextNode, IID_NULL, LOCALE_USER_DEFAULT,

DISPATCH_METHOD, &dp, pVarResult, NULL, &argerrnum

};

| delete dp.rgvarg; | |
|---|---|
| // MP5 - prepare output for data delivery | |
| // MP6 - data delivery (simulated) | |
| pDisp4 = pVarResult->pdispVal; | // store textnode obj in simulated |

ptr list

| VariantInit (pVarResult); | |
|---|---|
| // MP2 - date delivery simulation | |
| // MP43 - prepare for invoker | |
| dp.rgvarg = new VARIANTARG[1]; | |
| dp.rgdispidNamedArgs = NULL; | // Dispatch IDs of named arguments. |

| | |
|---|---|
| dp.cArgs = 1; | // Number of arguments. |
| dp.cNamedArgs = 0; | // Number of named arguments. |

| dp.rgvarg[0].vt = VT_DISPATCH; | |
|---|---|
| dp.rgvarg[0].pdispVal = pDisp4; | // append textnode object to body |

node

// MP46 - runtime interface invoker
// cause a newly created object to become visible
hr = pDisp3->Invoke(appendChild, IID_NULL, LOCALE_USER_DEFAULT,

DISPATCH_METHOD, &dp, pVarResult, NULL, &argerrnum

};

delete dp.rgvarg;
VariantInit (pVarResult);
// repeat wait indefinitely
while (progend == 0)// set in MyEventCallback
{

setm = SetWaitableTimer(hTimer, &liDueTime, 0, NULL, NULL, TRUE);
waitm = WaitForSingleObject(hTimer, INFINITE);

}
CloseIE6 (pDisp);

}
return hr;

}
HRESULT ie6::CloseIE6(IDispatch *pDisp)
{

| HRESULT hr = S_OK; | |
|---|---|
| DISPPARAMS | dp; |
| VARIANTARG | VarResult; |

VariantInit (&VarResult);
if (pDisp)
{

| // MP2 - data delivery simulation | |
|---|---|
| // MP43 - prepare for invoker | |
| long Quit = 300; | |
| dp.rgdispidNamedArgs = NULL; | // Dispatch IDs of named arguments. |

| | |
|---|---|
| dp.cArgs = 0; | // Number of arguments. |
| dp.cNamedArgs = 0; | // Number of named arguments. |

// MP46 - runtime interface invoker
// completes initialization (first page)
hr = pDisp->Invoke(Quit, IID_NULL, LOCALE_USER_DEFAULT,

DISPATCH_METHOD, &dp, &VarResult, NULL,

NULL);

}
return hr;

}
// ie6.h: interface for the ie6 class.
//
/////////////////////////////////////////////////////////////////////
#if !defined(AFX_IE6_H_3419F638_62DA_46C2_843E_89E6E4F51C0D_INCLUDED_)
#define AFX_IE6_H_3419F638_62DA_46C2_843E_89E6E4F51C0D_INCLUDED_
#define _WIN32_WINNT 0x0400
#include <comdef.h>
#include <windows.h>
#if _MSC_VER > 1000
#pragma once
#endif // _MSC_VER > 1000
_COM_SMARTPTR_TYPEDEF(IDispatch,_uuidof(IDispatch));
_COM_SMARTPTR_TYPEDEF(IUnknown,_uuidof(IUnknown));
class ie6
{
public:

HRESULT CloseIE6(IDispatch *);
HRESULT StartIE6( );
ie6( )
virtual ˜ie6( );
// simulation of MP3 - volatile pointer list

| | |
|---|---|
| IDispatchPtr pDisp; | //ie object |

IDispatchPtr pDisp1;//document object
IDispatchPtr pDisp2;//text box object
IDispatchPtr pDisp3;//document body object
IDispatchPtr pDisp4;//textnode object

unsigned char progend;

};
#endif // !defined(AFX_IE6_H_3419F638_62DA_46C2_843E_89E6E4F51C0D_INCLUDED_)

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and structural and functional equivalents thereof.

In addition, in the method claims that follow, the steps have been ordered in selected typographical sequences. However, the sequences have been selected and so ordered for typographical convenience and are not intended to imply any particular order for performing the steps, except for any claims wherein a particular ordering of steps is expressly set forth or understood by one of ordinary skill in the art as being necessary.

I claim:

1. A software architecture for providing instructions for one or more processors to manage data relating to binary objects using data storage hardware, comprising:
(a) a binary object manager program module for calling stored database procedures;
(b) a data delivery module for delivering a data array including data for instantiating the binary objects; and
(c) a database module, including:
(i) stored data relating to said binary objects; and
(ii) one or more stored procedures for managing and delivering binary object-related data through the binary object manager program module.

2. The software architecture of claim 1, the data delivery module further for setting a current array value to zero and making a next array the current array.

3. The software architecture of claim 2, the data delivery module further for unpacking said current array, identifying a target destination for said current array, delivering an iteration of said current array to said target destination, completing said iteration of said current array, and getting a further input data array.

4. The software architecture of claim 3, the data delivery module further for making said further input data array the current array, and incrementing the current array value by one.

5. The software architecture of claim 2, the data delivery module further for stopping a data delivery iteration.

6. The software architecture of claim 1, the data delivery module further for identifying a target destination for said data array as said binary object manager program module.

7. The software architecture of claim 6, the binary object manager program module for receiving a data array with an existing volatile object pointer index value of null.

8. The software architecture of claim 7, the binary object manager program module further for creating a binary object using an object name.

9. The software architecture of claim 8, the binary object program manager program module further for preparing output data for delivery including setting up said data array and identifying a next target destination for said data array.

10. The software architecture of claim 9, the binary object program manager module further for sending said output data to said next target destination for a new data delivery iteration.

11. The software architecture of claim 7, the binary object manager program module further for releasing said binary object.

12. The software architecture of claim 11, the binary object manager program module further for sending a no-data return to said binary object manager program module to perform a new data delivery iteration.

13. The software architecture of claim 6, the binary object manager program module for receiving a data array with an existing volatile object pointer index value not of null.

14. The software architecture of claim 13, the binary object manager program module further using said volatile object pointer index value to select a binary object to reference.

15. The software architecture of claim 14, the binary object manager program module further for creating a binary object using a parent binary object.

16. The software architecture of claim 14, the binary object manager program module further for preparing output data for delivery including setting up said data array and identifying a next target destination for said data array.

17. The software architecture of claim 16, the binary object manager program module further for sending said output data to said next target destination for a new data delivery iteration.

18. The software architecture of claim 14, the binary object manager program module further for identifying and releasing a binary object.

19. The software architecture of claim 18, the binary object manager program module further for sending a no-data return and to perform a new data delivery iteration.

20. The software architecture of claim 6, the binary object manager program module for using said volatile object pointer index value to select a binary object volatile pointer.

21. The software architecture of claim 20, the binary object manager program module further for using said binary object volatile pointer to prepare a managed object target function.

22. The software architecture of claim 21, the binary object manager program module further for executing said target function by invoking a binary object runtime interface function.

23. The software architecture of claim 22, the binary object manager program module further for preparing output data for delivery including setting up said data array and identifying a next target destination for said data array.

24. The software architecture of claim 23, the binary object manager program module further for sending a no-data return to said binary object manager program module to perform a new data delivery iteration.

25. The software architecture of claim 20, the binary object manager program module further for using said binary object volatile pointer to prepare a property access call.

26. The software architecture of claim 25, the binary object manager program module further for executing said property access call by invoking a binary object runtime interface function.

27. The software architecture of claim 26, the binary object manager program module further for preparing output data for delivery including setting up said data array and identifying a next target destination for said data array.

28. The software architecture of claim 27, the binary object manager program module further for sending a no-data return to said binary object manager program module to perform a new data delivery iteration.

29. The software architecture of claim 1, the database module for creating and manipulating said binary object.

30. The software architecture of claim 1, the database module further for identifying a target destination for said data array as said database module.

31. The software architecture of claim 30, the database module further for creating and manipulating said binary object.

32. The software architecture of claim 30, the database module further for receiving said data array with an existing volatile object pointer index value of null.

33. The software architecture of claim 30, the database module further for creating and manipulating said binary object.

34. The software architecture of claim 33, the database module further for receiving an “event has fired” call, and in response, preparing an “event has fired” database procedure call.

35. The software architecture of claim 34, the database module further for delivering a next data array to a database.

36. The software architecture of claim 35, the database module further for preparing output data for delivery including setting up the next data array, and identifying a next target destination for the next data array.

37. The software architecture of claim 36, the database module further for sending the output data to the next target destination for a new data delivery iteration.

38. The software architecture of claim 30, the database module for receiving the data array with an existing volatile object pointer index value not of null.

39. The software architecture of claim 38, the database module further for using the volatile object pointer index value to select a binary object to reference.

40. the software architecture of claim 39, the database module further for creating a binary object using a parent binary object.

41. The software architecture of claim 40, the database module further for receiving an “event has fired” call, and in response, preparing an “event has fired” database procedure call.

42. The software architecture of claim 41, the database module further for preparing output data for delivery including setting up the next data array, and identifying a next target destination for the next data array.

43. The software architecture of claim 42, the database module further for sending the output data to the next target destination for a new data delivery iteration.

44. The software architecture of claim 1, the data delivery module further for delivering an iteration of the current data array to a target destination.

45. The software architecture of claim 44, wherein said data delivery iteration includes setting the current array value to zero, receiving a next data array, unpacking the next data array, identifying the target destination for the data array, and sending the array to the target destination.

46. The software architecture of claim 45, wherein the target destination includes the binary object manager program module.

47. The software architecture of claim 45, wherein the target destination includes the database module.

48. The software architecture of claim 1, the database module further comprising a module for ending the life of managed binary objects.

49. The software architecture of claim 48, the module for ending the life of managed binary objects further for receiving an “event has fired” call, and in response, preparing an “event has fired” database procedure call.

50. The software architecture of claim 49, the module for ending the life of managed binary objects further for receiving a data array having data sufficient to instantiate a specific binary object, and preparing output data for delivery including setting up the data array and identifying a next target destination for the data array.

51. The software architecture of claim 50, the module for ending the life of managed binary objects further for sending the output data to the next target destination for a new data delivery iteration.

52. The software architecture of claim 51, the module for ending the life of managed binary objects further for receiving a data array from the data delivery module.

53. The software architecture of claim 52, wherein the data array received from the data delivery module by the module for ending the life of managed binary objects does not include an object Id, the module for ending the life of binary objects further for releasing all binary objects referencing all binary object pointer indexes at root pointer.

54. The software architecture of claim 52, wherein the data array received from the data delivery module by the module for ending the life of managed binary objects includes an object Id, the module for ending the life of binary objects further for referencing a single volatile object pointer corresponding to object Id provided and for releasing a designated object.

55. The software architecture of claim 1, wherein the data array is delivered along with a data array header.

56. The software architecture of claim 55, wherein the data array is further delivered along with a second data array and data array header pair.

57. The software architecture of claim 56, wherein the data array and data array header pairs are further delivered along with a data transaction header.

58. The software architecture of claim 1, further comprising a runtime interface for executing and accessing object functions and properties.

59. The software architecture of claim 58, the object functions and properties include an event establishing function.

60. The software architecture of claim 59, wherein a firing of the event results in a database procedure call.

61. The software architecture of claim 58, the runtime interface including an invoking function for one of a executing a function and accessing a property.

62. The software architecture of claim 58, further comprising a root pointer for managing a life of a binary object.

63. The software architecture of claim 1, further comprising a root pointer for managing a life of a binary object.

64. The software architecture of claim 63, further comprising a root pointer for ending a life of a binary object.

65. The software architecture of claim 63, wherein an object is created using a parent object from the root pointer.

66. The software architecture of claim 63, wherein an object is created using an object name.

67. The software architecture of claim 1, further comprising a volatile object pointer index for selecting a binary object to reference.

68. The software architecture of claim 67, wherein an object is created using a parent object from the root pointer, and output is prepared for data delivery.

69. The software architecture of claim 67, wherein an object is created using an object name, and output is prepared for data delivery.

70. A method for managing data relating to binary objects using one or more computer processors and data storage hardware, comprising the steps of:
storing data relating to a binary object at a database module of the data storage hardware;
storing one or more procedures at the database module for managing and delivering binary object-related data;
delivering a data array including data for instantiating the binary object; and
calling a stored database procedure for manipulating the binary object.

71. The method of claim 70, further comprising the steps of:
identifying a target destination for the data array as a binary object management program module; and
delivering the data to the binary object management program module.

72. The method of claim 70, further comprising the steps of:
identifying a target destination for the data array as the database module; and
delivering the data to the database module.

73. The method of claim 72, further comprising the step of creating and manipulating the binary object at the database module.

74. The method of claim 70, further comprising the step of creating the binary object from a parent binary object.

75. The method of claim 70, further comprising the step of creating the binary object from a binary object name.

76. The method of claim 70, further comprising the steps of:
creating the binary object;
receiving an “event has fired” call; and
preparing an “event has fired” database procedure call.

77. The method of claim 70, further comprising the step of ending the life of a managed binary object.

78. The method of claim 70, further comprising the step of delivering an iteration of a current data array to a target destination.

79. The method of claim 70, further comprising the step of executing and accessing object functions and properties.

80. A computer system for managing data relating to binary objects, comprising:
data storage hardware having a database module and a binary object management program module stored thereon for storing data relating to a binary object, and for storing one or more procedures for managing and delivering binary object-related data; and
one or more processors for delivering a data array including data for instantiating the binary object, and for calling a stored database procedure for manipulating the binary object.

81. The system of claim 80, the one or more processors further for:
identifying a target destination for the data array as a binary object management program module on the data storage hardware; and
delivering the data to the binary object management program module.

82. The system of claim 80, the one or more processors further for:
identifying a target destination for the data array as the database module on the data storage hardware; and
delivering the data to the database module.

83. The system of claim 82, the one or more processors further for creating and manipulating the binary object at the database module.

84. The system of claim 80, the one or more processors further for creating the binary object from a parent binary object.

85. The system of claim 80, the one or more processors further for creating the binary object from a binary object name.

86. The system of claim 80, the one or more processors further for:
creating the binary object;
receiving an “event has fired” call; and
preparing an “event has fired” database procedure call.

87. The system of claim 80, the one or more processors further for ending the life of a managed binary object.

88. The system of claim 80, the one or more processors further for delivering an iteration of a current data array to a target destination.

89. The system of claim 80, the one or more processors further for executing and accessing object functions and properties.
